(19) United States
(12) Patent Application Publication
(10) Pub. No.: US 2025/0373885 A1
(43) Pub. Date: Dec. 4, 2025

(54) VIDEO GENERATING METHOD, ELECTRONIC DEVICE AND NON-TRANSITORY COMPUTER-READABLE STORAGE MEDIUM

(71) Applicant: Beijing Zitiao Network Technology Co., Ltd., Beijing (CN)

(72) Inventors: Wenbin Wu, Beijing (CN); Leihe Zhao, Beijing (CN); Tun Yang, Beijing (CN); Bo Zhou, Beijing (CN); Zipei Peng, Beijing (CN)

(21) Appl. No.: 19/224,481

(22) Filed: May 30, 2025

(30) Foreign Application Priority Data
May 31, 2024 (CN) 202410705224.6

(51) Int. Cl. H04N 21/431; H04N 21/44; H04N 21/81; H04N 21/854

(52) U.S. Cl. CPC H04N 21/4318; H04N 21/44008; H04N 21/816; H04N 21/854

(57) ABSTRACT

A video generating method, an electronic device and a non-transitory computer-readable storage medium are provided. The video generating method includes: determining a reference video identifier specified by a current video editing task; determining reference video editing template information corresponding to the current video editing task based on the reference video identifier; and conducting video editing on a target multimedia material specified by the current video editing task based on the reference video editing template information, to obtain a target video.

This application claims priority from China Patent Application No. 202410705224.6 filed on May 31, 2024, and the disclosure of the above-mentioned China Patent Application is hereby incorporated in its entirety as a part of this application.

### TECHNICAL FIELD

Embodiments of the present disclosure relate to the field of data technology, in particular to a video generating method and apparatus, an electronic device and a non-transitory computer-readable storage medium.

### BACKGROUND

In the field of video processing, the supply of multimedia material editing templates is often constrained by the production capacity of designers. Creating video editing templates requires not only creativity but also technical skills. The number of designers and their work efficiency directly affect the supply of templates, resulting in a slow generation speed for video editing templates. Given the timeliness of trending topic videos, a delayed response in generating multimedia editing templates based on these topics may cause creators to miss the optimal moment to capitalize on trends, ultimately impacting the efficiency and effectiveness of video processing.

### SUMMARY

The present disclosure provides a video generating method and apparatus, an electronic device and a non-transitory computer-readable storage medium to address the issue of slow response to trending topics during video generation.

In a first aspect, embodiments of the present disclosure provide a video generation method which comprises:
determining a reference video identifier specified by a current video editing task;
determining reference video editing template information corresponding to the current video editing task based on the reference video identifier, in which the reference video editing template information is generated through a video editing template generation model based on reference video element information, the reference video editing template information allows a multimedia material to exhibit a video editing effect required for the current video editing task, the video editing template generation model is constructed based on a natural language processing model, and the reference video element information comprises a plurality of video element features generated by conducting video element decomposition on a reference video corresponding to the reference video identifier; and
conducting video editing on a target multimedia material specified by the current video editing task based on the reference video editing template information, to obtain a target video.

In a second aspect, embodiments of the present disclosure provide a video generation apparatus which comprises:
an understanding module, configured to determine a reference video identifier specified by a current video editing task;
a determination module, configured to determine reference video editing template information corresponding to the current video editing task based on the reference video identifier, in which the reference video editing template information is generated through a video editing template generation model based on reference video element information, the reference video editing template information allows a multimedia material to exhibit a video editing effect required for the current video editing task, the video editing template generation model is constructed based on a natural language processing model, and the reference video element information comprises a plurality of video element features generated by conducting video element decomposition on a reference video corresponding to the reference video identifier; and
a generation module, configured to conduct video editing on a target multimedia material specified by the current video editing task based on the reference video editing template information, to obtain a target video.

In a third aspect, embodiments of the present disclosure provide an electronic device, and the electronic device comprises:
at least one processor; and
a memory communicatively connected to at least one processor, wherein
the memory stores computer programs executable by the at least one processor, and the computer programs are executed by the at least one processor to enable the at least one processor to execute the video generating method of any one of the above embodiments.

In a forth aspect, embodiments of the present disclosure provide a computer-readable medium storing computer instructions, and the computer instructions is for causing a processor to execute the video generation method of any one of the above embodiments when the computer instructions is executed by the processor.

Embodiments of the present disclosure utilize a video editing template generation model based on a natural language processing model to conduct video element decomposition on a reference video to generate a plurality of video element features, and reference video editing template information is constructed according to the a plurality of video element features, which allows for the rapid generation of the reference video editing template information, and due to the ability of a natural language processing model to generate natural language texts, deeply understand text meanings, and handle various natural language tasks, the generated reference video editing template information can closely align with trending topics, consequently, videos that utilize the reference video editing template information will also align with trending topics. Additionally, for the generation of a target video, based on the reference video editing template information, the quick generation of the target video can be realized, thereby improving the efficiency of target video production.

It should be understood that what is described in this section is not intended to identify key or important features of embodiments of the present disclosure, nor is it intended to limit the scope of the present disclosure. Other features of the present disclosure will be readily understood from the following description.

### BRIEF DESCRIPTION OF DRAWINGS

The above and other features, advantages and aspects of the embodiments of the present disclosure will become more apparent with reference to the following detailed description taken in conjunction with the accompanying drawings. Throughout the drawings, the same or similar reference numerals indicate the same or similar elements. It should be understood that the drawings are schematic, and the original and elements are not necessarily drawn to scale.

FIG. 1 is a flow diagram of a video generating method provided by an embodiment of the present disclosure;

FIG. 2 is a flow diagram of another video generating method provided by an embodiment of the present disclosure;

FIG. 3 is an interaction diagram of a video generating method applicable to an embodiment of the present disclosure;

FIG. 4 is a flow diagram illustrating the process of generating reference video editing template information applicable to an embodiment of the present disclosure;

FIG. 5 is a schematic diagram illustrating a specific process of generating reference video editing template information applicable to an embodiment of the present disclosure;

FIG. 6 is a flow diagram illustrating the process of generating a target video applicable to an embodiment of the present disclosure;

FIG. 7 is a flow diagram of another video generating method applicable to an embodiment of the present disclosure;

FIG. 8 is a flow diagram illustrating a process of generating a target video according to a current reference video editing template applicable to an embodiment of the present disclosure;

FIG. 9 is a flow diagram illustrating the process of generating a target video according to an existing reference video editing template applicable to an embodiment of the present disclosure;

FIG. 10 is a schematic diagram of a video generation apparatus applicable to an embodiment of the present disclosure; and

FIG. 11 is a schematic diagram of an electronic device for implementing the video generating method according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple devices in the embodiments of the present disclosure are only for illustrative purposes, and are not intended to limit the scope of these messages or information.

It can be understood that before using the technical schemes disclosed in several embodiments of the present disclosure, users should be informed of the types, scope of use and usage scenarios of personal information involved in the present disclosure in an appropriate way in accordance with relevant laws and regulations, and user authorization is required.

For example, in response to receiving a proactive request from a user, a prompt message is sent to the user, explicitly stating that the operation the user requested will necessitate acquiring and utilizing the user's personal information, so that the user can decide whether to provide personal information to software or hardware such as electronic devices, applications, servers or storage media that perform the operation of the technical scheme of the present disclosure according to the prompt message.

As an alternative and non-restrictive implementation mode, in response to receiving the proactive request from the user, the way to send the prompt message to the user can be, for example, in the form of a pop-up window, in which the prompt message can be presented in text. In addition, the pop-up window can also contain selection controls “agree” and “disagree” for the user to choose regarding the provision of personal information to electronic devices.

It can be understood that the above notification and user authorization procedures are illustrative and do not limit the implementation modes of the present disclosure. Other methods that comply with relevant laws and regulations may also be applied in the implementation modes of the present disclosure.

It can be understood that the data involved in this technical scheme (including but not limited to the data itself, data acquisition or use) shall comply with the requirements of corresponding laws and regulations.

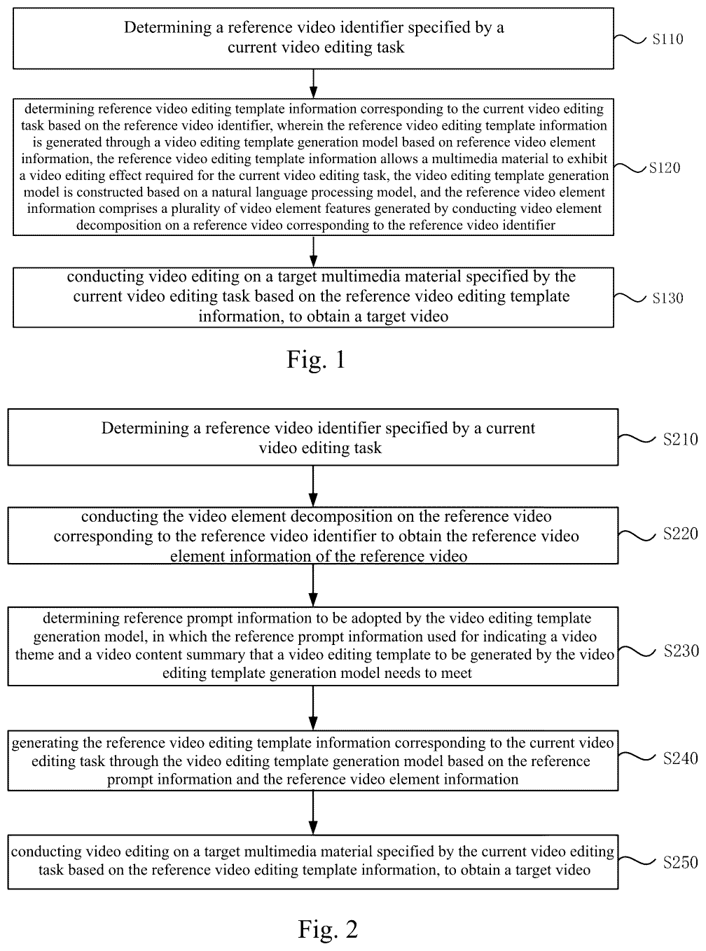

FIG. 1 is a flow diagram of a video generating method according to an embodiment of the present disclosure. The embodiments of the present disclosure are applicable to situations where a target video that has the same trending topic as a trending video needs to be generated after the trending video appears. The method can be performed by a video generation apparatus which can be implemented in the form of software and/or hardware, and is generally integrated on any electronic device with network communication function, such as a mobile terminal, a personal computer (PC) or a server.

As shown in FIG. 1, the video generating method provided by this embodiment may include the following steps.

S110, determining a reference video identifier specified by a current video editing task.

The video editing task may refer to a task of generating a video that has the same trending topic as a reference video corresponding to the reference video identifier.

The multimedia material may include at least one selected from the group consisting of videos, images, and audio, and the like. The reference video identifier may be a unique identifier for the reference video specified by the current video editing task, and can be used to search for the reference video, etc. The reference video may be a trending video at the current moment. For example, a video with a reference quantity greater than a preset reference quantity may be considered as the reference video. The reference quantity may include metrics such as view count, comment count, like count, and favorite count.

Further, for the selection of the reference video, videos on the same theme may be ranked based on their view counts, videos with a view count greater than a preset view count and ranking within a predefined number are considered as reference videos for this theme.

Because each uploaded video has a unique identifier, the playback link and storage information of the video can be found through the identifier. Therefore, the reference video can be accurately found through the reference video identifier of the reference video.

S120, determining reference video editing template information corresponding to the current video editing task based on the reference video identifier, wherein the reference video editing template information is generated through a video editing template generation model based on reference video element information, the reference video editing template information allows a multimedia material to exhibit a video editing effect required for the current video editing task, the video editing template generation model is constructed based on a natural language processing model, and the reference video element information comprises a plurality of video element features generated by conducting video element decomposition on a reference video corresponding to the reference video identifier.

The video editing template generation model is trained based on a natural language processing model (LLM). The natural language processing model (LLM) is a deep learning model trained on text data which can generate natural language text, deeply understand textual meanings, and handle various natural language tasks. The video element features may be features in the reference video which has trending attributes.

After the reference video identifier is determined, information such as the playback link and storage address of the reference video can be accurately found, thereby obtaining the reference video.

When generating a video, even though a video theme and necessary multimedia materials are determined, different video editors may produce varying results based on the video theme and the multimedia materials, leading to differences in video quality and varying degrees of similarity to current trending videos. To enhance the quality of the generated video and ensure that the video closely aligns with the current trending topic, during the generation process of the video, the reference video can be referenced to generate reference video editing template information corresponding to the reference model, and the video can be generated based on the reference video editing template information, thus improving the video quality of the video to be generated.

To improve the efficiency of determining the reference video editing template information, a video editing template generation model is trained using a natural language processing model (LLM) which can understand video content and generate a corresponding video editing template. As a result, when the reference video is disassembled through the video editing template generation model, the reference video can be disassembled quickly, and the characteristic video element features in the reference video can be obtained, and, the reference video editing template information can be generated based on the video element features, thus improving the generation efficiency of the video editing template.

S130, conducting video editing on a target multimedia material specified by the current video editing task based on the reference video editing template information, to obtain a target video.

Because the reference video editing template information is the video editing template information that is generated through the video editing template generation model based on the reference video element information and allows the multimedia material to exhibit the the video editing effect required for the current video editing task, the reference video editing template information can be used to conduct video editing on the target multimedia material, to obtain the target video which contains the reference video element information in the reference video.

Because the reference video editing template information is obtained from the reference video and the reference video is the trending video at the current moment, the target video generated based on the reference video editing template information will also exhibit similar features to the reference video, thereby enable the target video to be closely aligned with current trending topic.

In embodiments of the present disclosure, a video editing template generation model based on the natural language processing model is utilized to conduct video element decomposition on a reference video to generate a plurality of video element features, and reference video editing template information is constructed according to the a plurality of video element features, which allows for the rapid generation of the reference video editing template information, and due to the ability of a natural language processing model of generating natural language text, deeply understanding text meanings, and handling various natural language tasks, the generated reference video editing template information can closely align with trending topics, and consequently, videos that cited the reference video editing template information can also closely align with trending topics. Additionally, for the generation of the target video, based on the reference video editing template information, the quick generation of the target video can be realized, thereby improving the generation efficiency of the target video.

FIG. 2 is a flow diagram of another video generating method according to an embodiment of the present disclosure. The technical scheme of this embodiment further optimizes the process of determining reference video editing template information corresponding to the current video editing task based on the reference video identifier in the aforementioned embodiments. This embodiment can be combined with various alternative schemes in one or more of the aforementioned embodiments.

As shown in FIG. 2, the video generating method provided by this embodiment may include the following steps.

S210, determining a reference video identifier specified by a current video editing task.

S220, conducting video element decomposition on a reference video corresponding to the reference video identifier to obtain reference video element information of the reference video.

The reference video element information may be feature information in the reference video, including but not limited to audio, visual elements (such as stickers and GIFs), and transition videos.

Alternatively, the determination of the reference video editing template information may be conducted via a remote server or on a device that generates the target video.

Based on the reference video identifier, information such as the playback address and storage location of the reference video may be determined, thereby the reference video is obtained. In this case, the means of video element decomposition, such as audio extraction and video extraction, can be performed on the reference video, so as to acquire the distinctive audio, visual elements (such as stickers and GIFs) and transition videos in the reference video, thereby obtaining the reference video element information of the reference video.

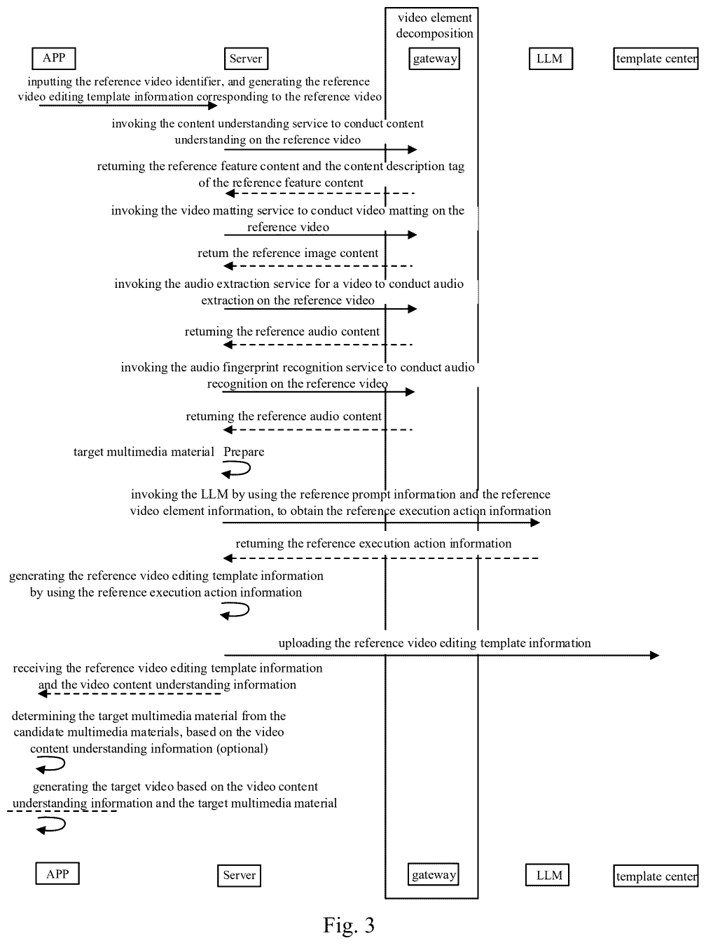

As an example, FIG. 3 is an interaction diagram of a video generating method applicable to an embodiment of the present disclosure. Referring to FIG. 3, when the APP wants to generate a target video having the same trending elements as the reference video, the reference video identifier of the reference video needs to be sent to a backend server. The backend server is responsible for obtaining the reference video based on the reference video identifier and conducting video element decomposition on the reference video to obtain the reference video element information of the reference video.

As an alternative but non-limiting implementation, conducting video element decomposition on a reference video corresponding to the reference video identifier to obtain reference video element information of the reference video may include steps A1-A3.

Step A1, conducting content understanding on the reference video corresponding to the reference video identifier, to obtain a reference feature content corresponding to the reference video and a content description tag of the reference feature content.

Step A2, conducting video matting on the reference video corresponding to the reference video identifier, to obtain a reference image content corresponding to the reference video.

Step A3, conducting an audio recognition on the reference video corresponding to the reference video identifier, to obtain a reference audio content corresponding to the reference video.

The reference feature content may be content understanding results obtained by conducting content understanding on the reference video. The content description tags of the reference feature content may be specific information used to describe the content understanding results corresponding to the reference video. The video editing template generation model conducts content understanding on the video content of the reference video, so as to identify distinctive content in the reference video as the reference feature content of the reference video, and generates specific descriptions of the reference feature content, which serves as the content description tags of the reference feature content, through understanding of the reference feature content.

Since the reference feature content in the reference video includes image-based reference image content and audio-based reference audio content, separate extractions of the different kinds of reference feature contents are required. For the reference image content, video matting can be conducted on distinctive video images in the reference video to obtain the reference image content corresponding to the reference video. For the reference audio content, audio recognition can be conducted on distinctive audio in the reference video to obtain the reference audio content corresponding to the reference video.

As an example, the video content of the reference video is “a white cat is chasing a butterfly on the lawn” and the background music is “A”, after conducting content understanding on the video content of the reference video, the reference feature content may be identified as “cat chasing butterfly”; additionally, by conducting audio recognition on the reference video, the reference video element information of the reference video is determined as “A”.

Alternatively, content understanding of the reference video corresponding to the reference video identifier may be performed using plugins or other services with content understanding capabilities in a gateway.

Alternatively, video matting of the reference video corresponding to the reference video identifier may be performed using plugins or other services with a video matting function in a gateway.

Alternatively, audio recognition of the reference video corresponding to the reference video identifier may be performed using plugins or other services with a video sound extraction function in a gateway.

As an alternative but non-limiting implementation, conducting the content understanding on the reference video corresponding to the reference video identifier to obtain the reference feature content corresponding to the reference video may include steps B1-B2.

Step B1, performing segment decomposition on the reference video corresponding to the reference video identifier, to obtain a plurality of reference video segments.

Step B2, conducting content understanding on each reference video segment to extract a first feature content and a second feature content from the reference video corresponding to the reference video identifier, so as to obtain the reference feature content corresponding to the reference video, in which the first feature content includes a key feature extracted from the reference video which can represent the reference video, and the second feature content includes a highlight segment in the reference video.

After obtaining the reference video, to facilitate the content understanding of the reference video by the video editing template generation model, the reference video needs to be segmented into multiple smaller data-sized reference video segments.

By conducting content understanding on each reference video segment and extracting feature content from each reference video segment, to obtain the first feature content and second feature content in the reference video segments. The first feature content and the second feature content from each reference video segment are then integrated to obtain the first feature content and the second feature content extracted from the reference video.

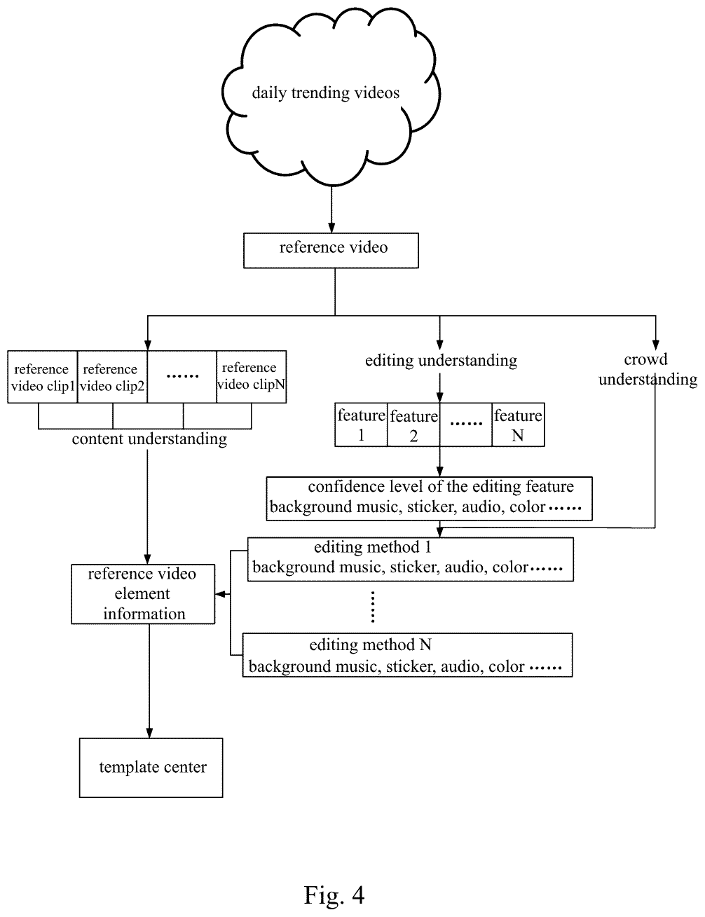

As an example, FIG. 4 is a flow diagram illustrating the process of generating the reference video editing template information applicable to an embodiment of the present disclosure. As shown in FIG. 4, the reference video is selected from daily trending videos, which is then segmented into multiple reference video segments, and content understanding is conducted on each reference video segment. Additionally, it is necessary to determine video features in the reference video, using a method based on the confidence levels of editing features. In addition, user preferences of the user generating the target video may also be considered. Based on the results of content understanding, the determination result of the video features, and the determination result of the user preferences, the reference video editing template information is generated and finally sent to a template center for storage.

As an alternative but non-limiting implementation, conducting the audio recognition on the reference video corresponding to the reference video identifier to obtain the reference audio content corresponding to the reference video may include steps C1-C2.

Step C1, conducting audio extraction on audio included in the reference video corresponding to the reference video identifier, to obtain the reference audio content corresponding to the reference video.

Step C2, conducting audio fingerprint recognition on audio included in the reference video corresponding to the reference video identifier, to obtain the reference audio content corresponding to the reference video.

To ensure the accuracy of audio extraction from the reference video, it is required to conduct the audio extraction on the audio included in the reference video first, so as to obtain a separate reference audio content. Then, the audio fingerprint recognition is conducted on the separate reference audio content to identify an original audio file corresponding to the reference audio content, and the original audio file is then taken as the reference audio content.

Alternatively, audio with the same content as the reference audio content and a quality higher than a preset standard is selected as the reference audio content. Alternatively, audio fingerprint recognition is performed on the audio included in the reference video corresponding to the reference video identifier, this audio fingerprint recognition may be performed by using plugins or other services with audio fingerprint recognition capabilities associated with a gateway.

As an example, referring to FIG. 3, after the backend server identifies the reference video, services in the gateway will be invoked to process the reference video. This processing includes content understanding, video matting, audio fingerprint recognition, and video extraction. After the services in the gateway complete processing the reference video, the processing result will be returned to the backend server.

S230, determining reference prompt information to be adopted by the video editing template generation model, in which the reference prompt information used for indicating a video theme and a video content summary that a video editing template to be generated by the video editing template generation model needs to meet.

Before generating the reference video editing template information using the video editing template generation model, it is necessary to determine the a video theme and a video content summary of the video to be produced. This ensures that the video editing template generation model has a more accurate direction when generating the reference video editing template information.

S240, generating the reference video editing template information corresponding to the current video editing task through the video editing template generation model based on the reference prompt information and the reference video element information.

The reference video editing template information is generated through a video editing template generation model based on reference video element information, allowing multimedia material to exhibit a video editing effect required for the current video editing task, the video editing template generation model is constructed based on a natural language processing model, and the reference video element information includes a plurality of video element features generated by conducting video element decomposition on the reference video corresponding to the reference video identifier.

After the reference video element information is determined, the video editing template generation model has the necessary materials to generate the reference video editing template information. After obtaining the reference prompt information, the video editing template generation model also possesses a video theme and a video content summary. In this case, the video editing template generation model can use the video theme and the video content summary as the direction for generating the template, and use the reference video element information as the materials to generate the reference video editing template information, thereby achieving the generation of the reference video editing template information.

As an alternative but non-limiting implementation, generating the reference video editing template information corresponding to the current video editing task through the video editing template generation model based on the reference prompt information and the reference video element information may include steps D1-D2.

Step D1, outputting reference execution action information through the video editing template generation model based on the reference prompt information and the reference video element information, wherein the reference execution action information is used for indicating reference video editing operations performed on a multimedia material indicated by the reference video element information, and execution logic between the reference video editing operations, during video editing template generation.

Step D2, placing the multimedia material indicated by the reference video element information on a video editing track based on the reference execution action information, to obtain the reference video editing template information corresponding to the current video editing task.

When generating the reference video editing template information, the video editing template generation model uses the reference prompt information and the reference video element information to determine the reference video editing operations to be performed on the multimedia material indicated by the reference video element information. The reference video editing operations may include audio insertion, text editing, and the addition of transition animations. The execution logic between the reference video editing operations represents the reference video editing operations to be executed at different times.

As an alternative but non-limiting implementation, outputting the reference execution action information through the video editing template generation model based on the reference prompt information and the reference video element information may include steps E1-E2.

Step E1, determining a candidate video editing operation adopted when the video editing template generation model generates the video editing template.

Step E2, outputting the reference execution action information through the video editing template generation model based on the candidate video editing operation, the reference prompt information and the reference video element information.

The candidate video editing operation may be an operation that a device used for target video generation is capable of performing.

Due to certain performance constraints of some devices used for target video generation, it is necessary to first identify video editing operations that the devices used for target video generation can support, and these video editing operations serve as the candidate video editing operation. When generating the reference execution action information through the video editing template generation model, the candidate video editing operations are used as constraints for generating the reference execution action information.

Alternatively, in addition to using the candidate video editing operations as constraints during the process of generating the reference execution action information, the required calculation amount at any moment during the process of generating the reference execution action information is less than the preset calculation amount, which prevents the issue of excessive calculation amount at any particular moment when executing the reference execution action information during the generation of the target video, which may potentially cause damage to the device used for target video generation.

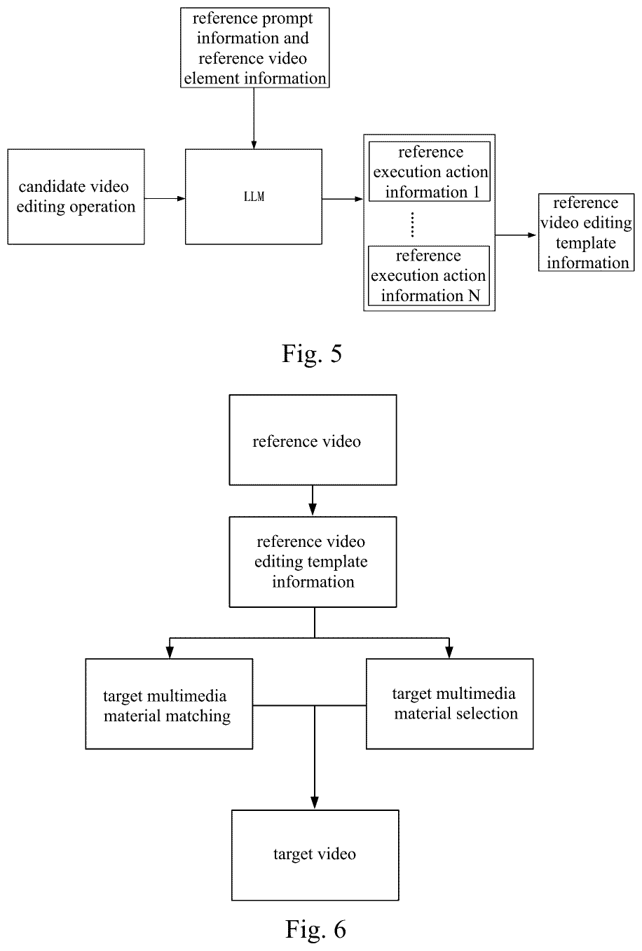

As an example, referring to FIG. 3, after the backend server receives the reference video element information of the reference video, the reference video element information is sent to the LLM for processing, and then the reference execution action information which can produce the reference video editing template information is generated, and the reference execution action information is returned to the backend server. The backend server then generates the reference video editing template information based on the reference execution action information. Referring to FIG. 5, after obtaining the reference prompt information and the reference video element information, the reference prompt information and the reference video element information along with the candidate video editing operation are input into the LLM. The LLM processes the reference prompt information and the reference video element information using the candidate video editing operation as the constraint to generate the reference video editing template information.

S250, conducting video editing on a target multimedia material specified by the current video editing task based on the reference video editing template information, to obtain a target video.

As an alternative but non-limiting implementation, conducting the video editing on the target multimedia material specified by the current video editing task based on the reference video editing template information, to obtain the target video may include steps F1-F3.

Step F1, determining video content understanding information corresponding to the reference editing template information, wherein the video content understanding information is used for describing a video theme and a video content summary to be edited and generated by the reference editing template information.

Step F2, determining video content understanding information corresponding to the reference editing template information, wherein the video content understanding information is used for describing a video theme and a video content summary to be edited and generated by the reference editing template information.

Step F3, determining video content understanding information corresponding to the reference editing template information, wherein the video content understanding information is used for describing a video theme and a video content summary to be edited and generated by the reference editing template information.

After determining the reference video editing template information, there may be some instances where multimedia material edited using the reference video editing template information do not match the reference video editing template information. To address this, the video theme and the video content summary corresponding to the reference editing template information may be determined according to the video content understanding information corresponding to the reference editing template information. By means of the video theme and the video content summary, the operation of matching the candidate multimedia material with the reference editing template information is performed, to identify the candidate multimedia material that matches the reference editing template information, and this candidate multimedia material serves as the target multimedia material. In this case, the target multimedia material may be inserted into corresponding positions on the video editing track in the reference editing template information, thereby generating the target video.

Alternatively, in addition to matching the candidate multimedia material using the video content understanding information corresponding to the reference editing template information and identifying the target multimedia material therefrom, the reference editing template information may also be applied to specified multimedia materials, to ensure flexibility in use of the users.

As an example, referring to FIG. 3, after the backend server generates the reference video editing template information, both the reference video editing template information and the video content understanding information are sent to the APP, the APP then determines the target multimedia material that match the reference video editing template information from the candidate multimedia material based on the video content understanding information, ultimately generating the target video. As shown in FIG. 6, after obtaining the reference video, the reference video editing template information corresponding to the reference video will be determined according to the reference video. For the use of the reference video editing template information, it may be matched directly with the candidate multimedia materials to obtain the target multimedia material matching the reference video editing template information from the candidate multimedia materials, and the target video is generated according to the obtained target multimedia material and the reference video editing template information. Additionally, specific candidate multimedia material may be designated as the target multimedia material, and based on the specified target multimedia material and the reference video editing template information, the target video is generated.

In this embodiment, the reference video identifier specified by the current video editing task is determined, the video element decomposition is conducted on the reference video corresponding to the reference video identifier to obtain the reference video element information of the reference video, the reference prompt information to be adopted by the video editing template generation model is determined, the reference video editing template information corresponding to the current video editing task is generated through the video editing template generation model based on the reference prompt information and the reference video element information, video editing is performed on the target multimedia material specified by the current video editing task based on the reference video editing template information to obtain the target video. This process allows for the extraction of distinctive reference video element information from the reference video by conducting the video element decomposition on the reference video corresponding to the reference video identifier during the generation of the video editing template generation model, and the reference video element information is then used to construct the reference prompt information, ultimately the reference video editing template information is generated, so that the obtained reference video editing template information retains the characteristics of the reference video, thereby ensuring that the generated target video possesses similar video features to the reference video.

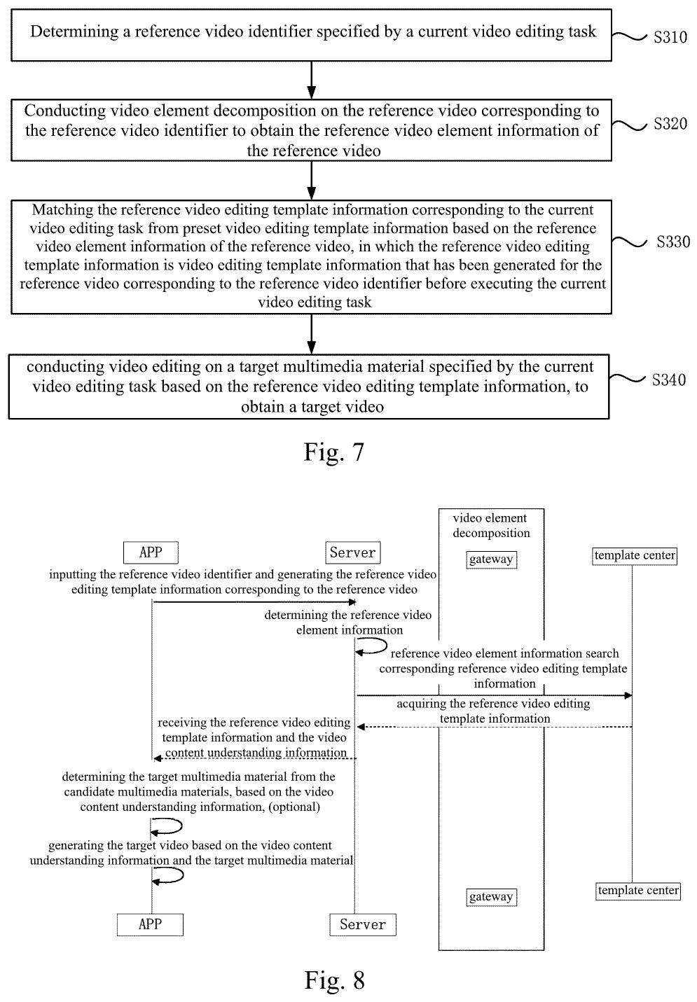

FIG. 7 is a flow diagram of another video generating method provided by an embodiment of the present disclosure. The technical scheme of this embodiment further optimizes the process of determining reference video editing template information corresponding to the current video editing task based on the reference video identifier in the aforementioned embodiments. This embodiment can be combined with various alternative schemes in one or more of the aforementioned embodiments.

As shown in FIG. 7, the video generating method provided by this embodiment may include the following steps.

S310, determining a reference video identifier specified by a current video editing task.

S320, conducting video element decomposition on the reference video corresponding to the reference video identifier to obtain the reference video element information of the reference video.

S330, matching the reference video editing template information corresponding to the current video editing task from preset video editing template information based on the reference video element information of the reference video, in which the reference video editing template information is video editing template information that has been generated for the reference video corresponding to the reference video identifier before executing the current video editing task.

Here, the construction of the reference video editing template information includes: conducting the video element decomposition on the reference video corresponding to the reference video identifier to obtain the reference video element information of the reference video; determining reference prompt information to be adopted by the video editing template generation model, wherein the reference prompt information used for indicating a video theme and a video content summary that a video editing template to be generated by the video editing template generation model needs to meet; and generating the reference video editing template information corresponding to the current video editing task through the video editing template generation model based on the reference prompt information and the reference video element information.

When generating the corresponding reference video editing template information based on the reference video, it is possible that the reference video editing template information has already been constructed. In this case, to avoid wasting computational resources on the devices used to generate the reference video editing template information if the reference video editing template information is created again, the reference video editing template information corresponding to the reference video will not be created again. Instead, the reference video editing template information corresponding to the current video editing task is determined by matching from the preset video editing template information storing reference video editing template information based on the reference video element information of the reference video.

Alternatively, in addition to matching the reference video editing template information corresponding to the current video editing task from the preset video editing template information based on the reference video element information of the reference video, it is possible to match preset video editing template information which has a similarity to the reference video editing template information corresponding to the reference video greater than a preset similarity.

Referring to FIG. 8, when the APP wants to generate a target video based on the reference video, the APP sends the reference video identifier of the reference video to the backend server first, the backend server then generates the reference video editing template information corresponding to the reference video identifier. After generating other video editing template information, to avoid redundant calculations that may lead to wasted computational resources, the backend server first determines the reference video element information in the reference video and sends the reference video element information in the reference video to a template center. The template center then checks, based on the reference video element information, whether the corresponding reference video editing template information has already existed. If the corresponding reference video editing template information has already existed, the corresponding reference video editing template information is directly obtained and sent to the backend server, and the backend server then forwards the received reference video editing template information to the APP.

S340, conducting video editing on a target multimedia material specified by the current video editing task based on the reference video editing template information, to obtain a target video.

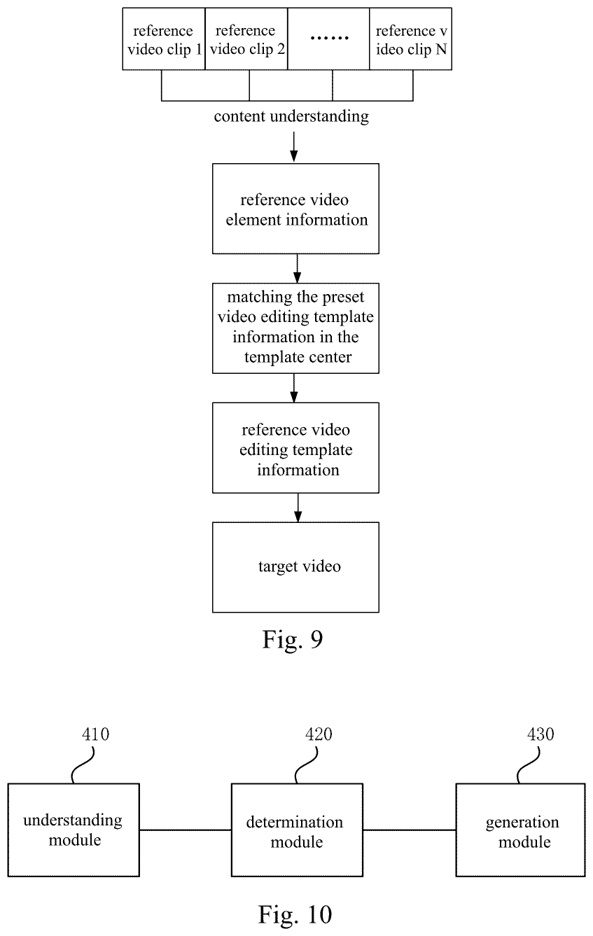

Referring to FIG. 9, after conducting content understanding on each reference video segment, the reference video element information corresponding to the reference video can be obtained. Based on the reference video element information, the reference video editing template information corresponding to the current video editing task is matched or selected from the preset video editing template information. Finally, video editing is performed on the target multimedia material based on the reference video editing template information to obtain the target video.

In this embodiment, the reference video identifier specified by the current video editing task is determined, the video element decomposition is conducted on the reference video corresponding to the reference video identifier to obtain the reference video element information of the reference video, the reference video editing template information corresponding to the current video editing task is matched or selected from the preset video editing template information based on the reference video element information of the reference video, video editing is conducted on the target multimedia material specified by the current video editing task based on the reference video editing template information, to obtain the target video, which can avoid the re-generation of reference video editing template information once it has been generated, thereby preventing a waste of computational resources on the device that generate the video editing template information.

FIG. 10 is a schematic diagram of a video generation apparatus according to an embodiment of the present disclosure. The embodiment of the present disclosure is applicable to situations where a target video needs to be generated that has the same trending topic as a trending video after it appears. The video generation apparatus can be implemented in the form of software and/or hardware, and is generally integrated on any electronic device with network communication function, such as a mobile terminal, a PC or a server.

As shown in FIG. 10, the video generation apparatus provided by the embodiment provided by the present disclosure may include an understanding module 410, a determination module 420 and a generation module 430.
the understanding module 410 is configured to determine a reference video identifier specified by a current video editing task;
the determination module 420 is configured to determine reference video editing template information corresponding to the current video editing task based on the reference video identifier, wherein the reference video editing template information is generated through a video editing template generation model based on reference video element information, the reference video editing template information allows a multimedia material to exhibit a video editing effect required for the current video editing task, the video editing template generation model is constructed based on a natural language processing model, and the reference video element information comprises a plurality of video element features generated by conducting video element decomposition on a reference video corresponding to the reference video identifier; and
the generation module 430 is configured to conduct video editing on a target multimedia material specified by the current video editing task based on the reference video editing template information, to obtain a target video.

Based on the above-mentioned embodiments, alternatively, the determination module 420 is configured to:
conduct the video element decomposition on the reference video corresponding to the reference video identifier to obtain the reference video element information of the reference video;
determine reference prompt information to be adopted by the video editing template generation model, wherein the reference prompt information used for indicating a video theme and a video content summary that a video editing template to be generated by the video editing template generation model needs to meet; and
generate the reference video editing template information corresponding to the current video editing task through the video editing template generation model based on the reference prompt information and the reference video element information.

Based on the above-mentioned embodiments, alternatively, the determination module 420 is configured to:
conduct the video element decomposition on the reference video corresponding to the reference video identifier, to obtain the reference video element information of the reference video;
match the reference video editing template information corresponding to the current video editing task from preset video editing template information based on the reference video element information of the reference video, wherein the reference video editing template information is video editing template information that has been generated for the reference video corresponding to the reference video identifier before executing the current video editing task;
a construction of the reference video editing template information comprises: conducting the video element decomposition on the reference video corresponding to the reference video identifier, to obtain the reference video element information of the reference video; determining reference prompt information to be adopted by the video editing template generation model, in which the reference prompt information is used for indicating a video theme and a video content summary that a video editing template to be generated by the video editing template generation model needs to meet; and generating the reference video editing template information corresponding to the current video editing task through the video editing template generation model based on the reference prompt information and the reference video element information.

Based on the above-mentioned embodiments, alternatively, conducting the video element decomposition on the reference video corresponding to the reference video identifier to obtain reference video element information of the reference video includes:
conducting content understanding on the reference video corresponding to the reference video identifier, to obtain a reference feature content corresponding to the reference video and a content description tag of the reference feature content;
conducting video matting on the reference video corresponding to the reference video identifier, to obtain a reference image content corresponding to the reference video;
conducting an audio recognition on the reference video corresponding to the reference video identifier, to obtain a reference audio content corresponding to the reference video, the reference audio content corresponding to the reference video is used as the reference video element information of the reference video.

Based on the above-mentioned embodiments, alternatively, conducting content understanding on the reference video corresponding to the reference video identifier, to obtain a reference feature content corresponding to the reference video includes:
performing segment decomposition on the reference video corresponding to the reference video identifier, to obtain a plurality of reference video segments; and
conducting content understanding on each reference video segment to extract a first feature content and a second feature content from the reference video corresponding to the reference video identifier, so as to obtain the reference feature content corresponding to the reference video, in which the first feature content includes a key feature extracted from the reference video which can represent the reference video, and the second feature content includes a highlight segment in the reference video.

Based on the above-mentioned embodiments, alternatively, conducting audio recognition on the reference video corresponding to the reference video identifier to obtain reference audio content corresponding to the reference video includes:
conducting audio extraction on audio included in the reference video corresponding to the reference video identifier, to obtain the reference audio content corresponding to the reference video; and
conducting audio fingerprint recognition on audio included in the reference video corresponding to the reference video identifier, to obtain the reference audio content corresponding to the reference video.

Based on the above-mentioned embodiments, alternatively, generating the reference video editing template information corresponding to the current video editing task through the video editing template generation model based on the reference prompt information and the reference video element information includes:
outputting reference execution action information through the video editing template generation model based on the reference prompt information and the reference video element information, wherein the reference execution action information is used for indicating reference video editing operations performed on a multimedia material indicated by the reference video element information, and execution logic between the reference video editing operations, during video editing template generation; and
placing the multimedia material indicated by the reference video element information on a video editing track based on the reference execution action information, to obtain the reference video editing template information corresponding to the current video editing task.

Based on the above-mentioned embodiments, alternatively, outputting the reference execution action information through the video editing template generation model based on the reference prompt information and the reference video element information includes:
determining a candidate video editing operation adopted when the video editing template generation model generates the video editing template; and
outputting the reference execution action information through the video editing template generation model based on the candidate video editing operation, the reference prompt information and the reference video element information.

Based on the above-mentioned embodiments, alternatively, the generation module 430 is configured to:
determine video content understanding information corresponding to the reference editing template information, and the video content understanding information is used for describing a video theme and a video content summary to be edited and generated by the reference editing template information;
determine video content understanding information corresponding to the reference editing template information, the video content understanding information is used for describing a video theme and a video content summary to be edited and generated by the reference editing template information; and
determine video content understanding information corresponding to the reference editing template information, wherein the video content understanding information is used for describing a video theme and a video content summary to be edited and generated by the reference editing template information.

According to the technical scheme provided by the embodiments of the present disclosure, the generated target video can be close to the hot spot, and by utilizing the video editing template generation model to create the reference video editing template information, the efficiency of the template generation is significantly improved, which enables the target video to be produced at a faster rate, avoiding the issue of creators missing out on the hot spot or trending topics due to a delayed response in generating multimedia editing templates.

The video generation apparatus provided by the embodiments can perform the video generating method provided by any embodiment of the present disclosure, and has corresponding functional modules for executing the video generating method and beneficial effects.

It should be noted that the plurality of units and modules included in the apparatus are categorized based on functional logic, but this classification is not restrictive, as long as corresponding functions can be realized. In addition, the names of multiple functional units are only for the convenience of distinguishing each other, and are not used to limit the protection scope of the embodiments of the present disclosure.

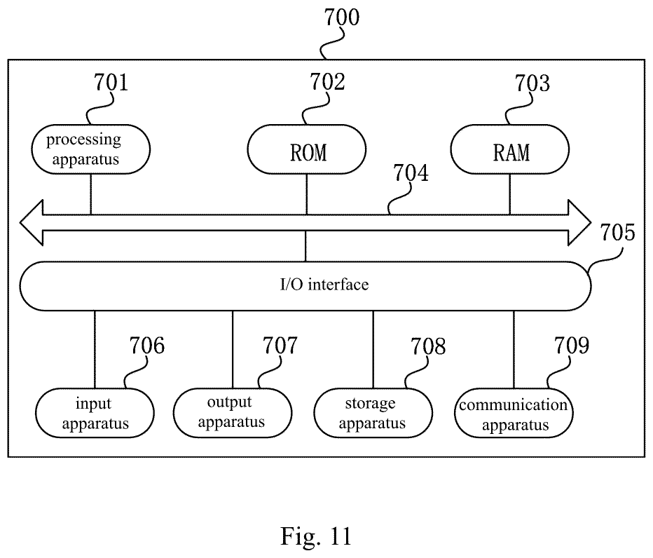

FIG. 11 is a schematic diagram of an electronic device for implementing the video generating method according to an embodiment of the present disclosure. FIG. 11 is referred below, and it shows the structure schematic diagram suitable for achieving the electronic device 700 (For example, a terminal device or a server in FIG. 11) in the embodiment of the present disclosure. The electronic device 700 in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 6 is only an example and should not impose any limitations on the functions and use scopes of the embodiments of the present disclosure.

As shown in FIG. 11, the electronic device 700 may include a processing apparatus (such as a central processing unit, and a graphics processor) 701, it may execute various appropriate actions and processes according to a program stored in a read-only memory (ROM) 702 or a program loaded from a storage apparatus 708 to a random access memory (RAM) 703. In RAM 703, various programs and data required for operations of the electronic device 700 are also stored. The processing apparatus 701, ROM 702, and RAM 703 are connected to each other by a bus 704. An input/output (I/O) interface 705 is also connected to the bus 704.

Typically, the following apparatuses may be connected to the I/O interface 705: an input apparatus 706 such as a touch screen, a touchpad, a keyboard, a mouse, a camera, a microphone, an accelerometer, and a gyroscope; an output apparatus 707 such as a liquid crystal display (LCD), a loudspeaker, and a vibrator; a storage apparatus 708 such as a magnetic tape, and a hard disk drive; and a communication apparatus 709. The communication apparatus 709 may allow the electronic device 700 to wireless-communicate or wire-communicate with other devices so as to exchange data. Although FIG. 6 shows the electronic device 700 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 709, or installed from the storage apparatus 708, or installed from ROM 702. When the computer program is executed by the processing apparatus 701, the above functions defined in the sight line tracking method in the embodiments of the present disclosure are executed.

The names of messages or information exchanged between multiple devices in the embodiments of the present disclosure are only for illustrative purposes, and are not intended to limit the scope of these messages or information.

The electronic device provided in this embodiment and the video generating method provided in the above embodiments belong to the same inventive concept. Technical details not described in this embodiment can be found in the above embodiment, and this embodiment has the same beneficial effects as the above embodiment.

Embodiments of the present disclosure provide a non-transitory computer-readable storage medium, on which a computer program is stored, when the computer program is executed by a processor, the video generating method provided in the above embodiment is implemented.

It should be noted that the computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a background image; display an initial picture of a target visual effect at a preset position of the background image; control the target visual effect to gradually change from the initial picture to a target picture in response to a visual effect change instruction triggered by a user; and adjust a filter effect of the background image to allow the filter effect of the background image to gradually change from a first filter effect to a second filter effect during a change of the target visual effect.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Specific manners of operations performed by the modules in the apparatus in the above embodiment have been described in detail in the embodiments regarding the method, which will not be explained and described in detail herein again.

1. A video generating method, comprising:
determining a reference video identifier specified by a current video editing task;
determining reference video editing template information corresponding to the current video editing task based on the reference video identifier, wherein the reference video editing template information is generated through a video editing template generation model based on reference video element information, the reference video editing template information allows a multimedia material to exhibit a video editing effect required for the current video editing task, the video editing template generation model is constructed based on a natural language processing model, and the reference video element information comprises a plurality of video element features generated by conducting video element decomposition on a reference video corresponding to the reference video identifier; and
conducting video editing on a target multimedia material specified by the current video editing task based on the reference video editing template information, to obtain a target video.

2. The method according to claim 1, wherein determining reference the video editing template information corresponding to the current video editing task based on the reference video identifier comprises:
conducting the video element decomposition on the reference video corresponding to the reference video identifier to obtain the reference video element information of the reference video;
determining reference prompt information to be adopted by the video editing template generation model, wherein the reference prompt information used for indicating a video theme and a video content summary that a video editing template to be generated by the video editing template generation model needs to meet; and
generating the reference video editing template information corresponding to the current video editing task through the video editing template generation model based on the reference prompt information and the reference video element information.

3. The method according to claim 1, wherein determining the reference video editing template information corresponding to the current video editing task based on the reference video identifier comprises:
conducting the video element decomposition on the reference video corresponding to the reference video identifier, to obtain the reference video element information of the reference video;
matching the reference video editing template information corresponding to the current video editing task from preset video editing template information based on the reference video element information of the reference video, wherein the reference video editing template information is video editing template information that has been generated for the reference video corresponding to the reference video identifier before executing the current video editing task;
a construction of the reference video editing template information comprises: conducting the video element decomposition on the reference video corresponding to the reference video identifier, to obtain the reference video element information of the reference video; determining reference prompt information to be adopted by the video editing template generation model, wherein the reference prompt information is used for indicating a video theme and a video content summary that a video editing template to be generated by the video editing template generation model needs to meet; and generating the reference video editing template information corresponding to the current video editing task through the video editing template generation model based on the reference prompt information and the reference video element information.

4. The method according to claim 2, wherein conducting the video element decomposition on the reference video corresponding to the reference video identifier to obtain the reference video element information of the reference video comprises:
conducting content understanding on the reference video corresponding to the reference video identifier, to obtain a reference feature content corresponding to the reference video and a content description tag of the reference feature content;
conducting video matting on the reference video corresponding to the reference video identifier, to obtain a reference image content corresponding to the reference video; and
conducting an audio recognition on the reference video corresponding to the reference video identifier, to obtain a reference audio content corresponding to the reference video.

5. The method according to claim 2, wherein generating the reference video editing template information corresponding to the current video editing task through the video editing template generation model based on the reference prompt information and the reference video element information comprises:
outputting reference execution action information through the video editing template generation model based on the reference prompt information and the reference video element information, wherein the reference execution action information is used for indicating reference video editing operations performed on a multimedia material indicated by the reference video element information, and execution logic between the reference video editing operations, during video editing template generation; and
placing the multimedia material indicated by the reference video element information on a video editing track based on the reference execution action information, to obtain the reference video editing template information corresponding to the current video editing task.

6. The method according to claim 5, wherein outputting the reference execution action information through the video editing template generation model based on the reference prompt information and the reference video element information comprises:
determining a candidate video editing operation adopted when the video editing template generation model generates the video editing template; and
outputting the reference execution action information through the video editing template generation model based on the candidate video editing operation, the reference prompt information and the reference video element information.

7. The method according to claim 1, wherein conducting the video editing on the target multimedia material specified by the current video editing task based on the reference video editing template information, to obtain the target video comprises:
determining video content understanding information corresponding to the reference editing template information, wherein the video content understanding information is used for describing a video theme and a video content summary to be edited and generated by the reference editing template information;
determining video content understanding information corresponding to the reference editing template information, wherein the video content understanding information is used for describing a video theme and a video content summary to be edited and generated by the reference editing template information; and
determining video content understanding information corresponding to the reference editing template information, wherein the video content understanding information is used for describing a video theme and a video content summary to be edited and generated by the reference editing template information.

8. The method according to claim 3, wherein conducting the video element decomposition on the reference video corresponding to the reference video identifier to obtain the reference video element information of the reference video comprises:
conducting content understanding on the reference video corresponding to the reference video identifier, to obtain a reference feature content corresponding to the reference video and a content description tag of the reference feature content;
conducting video matting on the reference video corresponding to the reference video identifier, to obtain a reference image content corresponding to the reference video; and
conducting an audio recognition on the reference video corresponding to the reference video identifier, to obtain a reference audio content corresponding to the reference video.

9. The method according to claim 3, wherein generating the reference video editing template information corresponding to the current video editing task through the video editing template generation model based on the reference prompt information and the reference video element information comprises:
outputting reference execution action information through the video editing template generation model based on the reference prompt information and the reference video element information, wherein the reference execution action information is used for indicating reference video editing operations performed on a multimedia material indicated by the reference video element information, and execution logic between the reference video editing operations, during video editing template generation; and
placing the multimedia material indicated by the reference video element information on a video editing track based on the reference execution action information, to obtain the reference video editing template information corresponding to the current video editing task.

10. The method according to claim 2, wherein conducting the video editing on the target multimedia material specified by the current video editing task based on the reference video editing template information, to obtain the target video comprises:
determining video content understanding information corresponding to the reference editing template information, wherein the video content understanding information is used for describing a video theme and a video content summary to be edited and generated by the reference editing template information;
determining the target multimedia material matching the reference video editing template information from candidate multimedia materials corresponding to the current video editing task based on the video content understanding information corresponding to the reference editing template information; and
conducting the video editing on the target multimedia material specified by the current video editing task based on the reference video editing template information, to obtain the target video.

11. The method according to claim 3, wherein conducting the video editing on the target multimedia material specified by the current video editing task based on the reference video editing template information, to obtain the target video comprises:
determining video content understanding information corresponding to the reference editing template information, wherein the video content understanding information is used for describing a video theme and a video content summary to be edited and generated by the reference editing template information;
determining the target multimedia material matching the reference video editing template information from candidate multimedia materials corresponding to the current video editing task based on the video content understanding information corresponding to the reference editing template information; and
conducting the video editing on the target multimedia material specified by the current video editing task based on the reference video editing template information, to obtain the target video.

12. The method according to claim 4, wherein conducting the video editing on the target multimedia material specified by the current video editing task based on the reference video editing template information, to obtain the target video comprises:
determining video content understanding information corresponding to the reference editing template information, wherein the video content understanding information is used for describing a video theme and a video content summary to be edited and generated by the reference editing template information;
determining the target multimedia material matching the reference video editing template information from candidate multimedia materials corresponding to the current video editing task based on the video content understanding information corresponding to the reference editing template information; and
conducting the video editing on the target multimedia material specified by the current video editing task based on the reference video editing template information, to obtain the target video.

13. The method according to claim 5, wherein conducting the video editing on the target multimedia material specified by the current video editing task based on the reference video editing template information, to obtain the target video comprises:
determining video content understanding information corresponding to the reference editing template information, wherein the video content understanding information is used for describing a video theme and a video content summary to be edited and generated by the reference editing template information;
determining the target multimedia material matching the reference video editing template information from candidate multimedia materials corresponding to the current video editing task based on the video content understanding information corresponding to the reference editing template information; and
conducting the video editing on the target multimedia material specified by the current video editing task based on the reference video editing template information, to obtain the target video.

14. The method according to claim 6, wherein conducting the video editing on the target multimedia material specified by the current video editing task based on the reference video editing template information, to obtain the target video comprises:
determining video content understanding information corresponding to the reference editing template information, wherein the video content understanding information is used for describing a video theme and a video content summary to be edited and generated by the reference editing template information;
determining the target multimedia material matching the reference video editing template information from candidate multimedia materials corresponding to the current video editing task based on the video content understanding information corresponding to the reference editing template information; and
conducting the video editing on the target multimedia material specified by the current video editing task based on the reference video editing template information, to obtain the target video.

15. An electronic device, comprising:
one or more processors; and
a memory configured to store one or more programs, wherein
upon the one or more programs being executed by the one or more processors, the one or more processors implements a video generating method;
the video generating method comprises:
determining a reference video identifier specified by a current video editing task;
determining reference video editing template information corresponding to the current video editing task based on the reference video identifier, wherein the reference video editing template information is generated through a video editing template generation model based on reference video element information, the reference video editing template information allows a multimedia material to exhibit a video editing effect required for the current video editing task, the video editing template generation model is constructed based on a natural language processing model, and the reference video element information comprises a plurality of video element features generated by conducting video element decomposition on a reference video corresponding to the reference video identifier; and
conducting video editing on a target multimedia material specified by the current video editing task based on the reference video editing template information, to obtain a target video.

16. The electronic device according to claim 15, wherein determining reference the video editing template information corresponding to the current video editing task based on the reference video identifier comprises:
conducting the video element decomposition on the reference video corresponding to the reference video identifier to obtain the reference video element information of the reference video;
determining reference prompt information to be adopted by the video editing template generation model, wherein the reference prompt information used for indicating a video theme and a video content summary that a video editing template to be generated by the video editing template generation model needs to meet; and
generating the reference video editing template information corresponding to the current video editing task through the video editing template generation model based on the reference prompt information and the reference video element information.

17. The electronic device according to claim 15, wherein determining the reference video editing template information corresponding to the current video editing task based on the reference video identifier comprises:
conducting the video element decomposition on the reference video corresponding to the reference video identifier, to obtain the reference video element information of the reference video;
matching the reference video editing template information corresponding to the current video editing task from preset video editing template information based on the reference video element information of the reference video, wherein the reference video editing template information is video editing template information that has been generated for the reference video corresponding to the reference video identifier before executing the current video editing task;
a construction of the reference video editing template information comprises: conducting the video element decomposition on the reference video corresponding to the reference video identifier, to obtain the reference video element information of the reference video; determining reference prompt information to be adopted by the video editing template generation model, wherein the reference prompt information is used for indicating a video theme and a video content summary that a video editing template to be generated by the video editing template generation model needs to meet; and generating the reference video editing template information corresponding to the current video editing task through the video editing template generation model based on the reference prompt information and the reference video element information.

18. The electronic device according to claim 16, wherein conducting the video element decomposition on the reference video corresponding to the reference video identifier to obtain the reference video element information of the reference video comprises:
conducting content understanding on the reference video corresponding to the reference video identifier, to obtain a reference feature content corresponding to the reference video and a content description tag of the reference feature content;
conducting video matting on the reference video corresponding to the reference video identifier, to obtain a reference image content corresponding to the reference video; and
conducting an audio recognition on the reference video corresponding to the reference video identifier, to obtain a reference audio content corresponding to the reference video.

19. The electronic device according to claim 17, wherein conducting the video element decomposition on the reference video corresponding to the reference video identifier to obtain the reference video element information of the reference video comprises:
conducting content understanding on the reference video corresponding to the reference video identifier, to obtain a reference feature content corresponding to the reference video and a content description tag of the reference feature content;
conducting video matting on the reference video corresponding to the reference video identifier, to obtain a reference image content corresponding to the reference video; and
conducting an audio recognition on the reference video corresponding to the reference video identifier, to obtain a reference audio content corresponding to the reference video.

20. A non-transitory computer-readable storage medium comprising computer-executable instructions, wherein upon the computer-executable instructions being executed by a computer processor, a video generating method is implemented;
the video generating method comprises:
determining a reference video identifier specified by a current video editing task;
determining reference video editing template information corresponding to the current video editing task based on the reference video identifier, wherein the reference video editing template information is generated through a video editing template generation model based on reference video element information, the reference video editing template information allows a multimedia material to exhibit a video editing effect required for the current video editing task, the video editing template generation model is constructed based on a natural language processing model, and the reference video element information comprises a plurality of video element features generated by conducting video element decomposition on a reference video corresponding to the reference video identifier; and
conducting video editing on a target multimedia material specified by the current video editing task based on the reference video editing template information, to obtain a target video.
